(19) United States
(12) Patent Application Publication
(10) Pub. No.: US 2025/0042041 A1
(43) Pub. Date: Feb. 6, 2025

(54) ROBOT HAND, IN PARTICULAR FOR CARRYING AN APPLICATION APPARATUS

(71) Applicant: Dürr Systems AG, Bietigheim-Bissingen (DE)

(72) Inventors: Sven Schweigler, Bietigheim-Bissingen (DE); Tobias Kleinhans, Benningen (DE); Arved Hess, Konstanz (DE)

(21) Appl. No.: 18/717,011

(22) PCT Filed: Jan. 10, 2023
(86) PCT No.: PCT/EP2023/050393

§ 371 Date: Jun. 6, 2024

(30) Foreign Application Priority Data
Jan. 12, 2022 (DE) 10 2022 100 608.5

(51) Int. Cl. B25J 11/00; B05B 13/04; B25J 9/10; B25J 13/08; B25J 15/00; B25J 17/00; B25J 19/00

(52) U.S. Cl. CPC B25J 11/0075; B05B 13/0431; B25J 9/1025; B25J 13/088; B25J 15/0019; B25J 17/00; B25J 19/0029; B25J 19/0054

(57) ABSTRACT

The disclosure concerns a robot hand, preferably for carrying an application apparatus preferably comprising a print head device, with a first joint structure which is rotatable about a first axis, a second joint structure which is rotatable about a second axis, and a third joint structure which is rotatable about a third axis, a line feed-through which extends through the first joint structure and through the third joint structure and preferably in which at least one line runs, and an offset between the first axis and the second axis.

### CROSS-REFERENCE TO RELATED APPLICATIONS

This application is a national stage of, and claims priority to, Patent Cooperation Treaty Application No. PCT/EP2023/050393, filed on Jan. 10, 2023, which application claims priority to German Application No. DE 10 2022 100 608.5, filed on Jan. 12, 2022, which applications are hereby incorporated herein by reference in their entireties.

### FIELD

The disclosure relates to a robot hand, in particular for carrying an application apparatus and preferably for mounting on an application robot. The application apparatus and/or the application robot is preferably used for painting motor vehicle body components.

### BACKGROUND

Robot-guided atomizers (e.g. rotary atomizers) for painting motor vehicle body components are, for precise path guidance, usually mounted on an actuator, referred to as a robot hand or robot hand axis, with one or more joints partially coupled with each other. An example of such a robot hand (robot hand axis) is disclosed, e.g., in EP 1 632 320 A1.

Drive trains of conventional robot hands for atomizers usually comprise gear wheels, shafts and bearings. This achieves the precision required when painting with atomizers.

However, atomizers have the disadvantage of limited application efficiency because usually only part of the applied paint is deposited on the components to be coated, while the rest of the applied paint has to be disposed of as so-called overspray.

A more recent line of development, on the other hand, envisages so-called print heads as the application apparatus, such as those known from DE 10 2013 002 412 A1 and DE 10 2010 019 612 A1. In contrast to the known atomizers, such print heads do not emit a spray mist of the paint to be applied, so that substantially no undesired overspray is produced.

The structure of the drive trains consisting of gear wheels, shafts and bearings described at the beginning does not achieve the accuracy that is desired when painting with in particular print heads.

Inaccuracies are caused, e.g., by play-prone toothings and elasticities of components, e.g. gear wheels and shafts, which can deform under load. Furthermore, the compact design that is often required results in couplings between the drive trains of the individual joints, which in turn increases the mechanical play and reduces the rigidity. This also makes it more difficult to calculate the necessary drive torques for high-precision movement of the TCP (Tool Center Point) and/or reduces accuracy.

The plurality of influencing variables to be parameterized (e.g. friction parameters, static and dynamic parameters, etc.) requires for their value-wise determination complex tests and/or the use of algorithms for estimation. Both lead to inaccuracies in the calculation, thus to an error-prone torque pre-control and thus to positioning inaccuracies of the robot hand.

### BRIEF DESCRIPTION OF THE DRAWINGS

FIG. 1 shows a perspective view of a robot hand according to an embodiment of the disclosure,

FIG. 2 shows a side view of the robot hand,

FIG. 3 shows another perspective view of the robot hand, with in particular schematically shown line feed-through and line,

FIG. 4 shows a perspective view of the robot hand, in particular with a measuring device for measurement of rotary positions of a second joint structure of the robot hand,

FIG. 5 shows a perspective view of the robot hand, in particular with a measuring device for measurement of rotary positions of a third joint structure of the robot hand,

FIG. 6 shows a perspective view of the robot hand, in particular with a measuring device for measurement of rotary positions of a first joint structure of the robot hand,

FIG. 7 shows a schematic view of an application robot with the robot hand, and

FIG. 8 shows an example of a schematic strain wave gear.

### DETAILED DESCRIPTION

The disclosure relates to a robot hand (e.g. a robot hand axis), preferably for carrying an application apparatus and/or e.g. for mounting on an application robot. The application apparatus can comprise, e.g., a print head device.

The robot hand comprises a first joint structure rotatable about a first axis, a second joint structure rotatable about a second axis, and a third joint structure rotatable about a third axis.

The robot hand comprises a line feed-through extending (e.g. axially) through the first joint structure and (e.g. axially) through the third joint structure. The line feed-through can expediently have a passage cross-section of preferably at least 40 mm to a maximum of 90 mm, e.g., in the first joint structure and/or in the third joint structure, preferably of e.g. 70 mm+/−5 mm.

It is possible that at least one line, e.g. at least one hose (e.g. media hose) and/or at least one cable (e.g. a control cable (e.g. a data cable) and/or a cable for preferably electrical power supply) runs in the line feed-through.

The robot hand can, e.g., comprise an application apparatus that can preferably be carried by the robot hand.

The application apparatus can, e.g., comprise a print head device, in particular with a plurality of nozzles for dispensing an application agent, for example for coating (e.g. painting) motor vehicle body components.

The print head device is used in particular for substantially overspray-free coating of the motor vehicle body components.

The at least one line can preferably comprise at least one media line (e.g. a media hose) for application agent supply (e.g. paint supply) and/or fluid supply (e.g. air supply, compressed air supply and/or rinsing agent supply) of the application apparatus and/or the print head device. Alternatively or additionally, the at least one line can comprise at least one cable, e.g. for electrical power supply and/or for controlling the application apparatus and/or the print head device.

The at least one line can also comprise, e.g., at least one media return line (e.g. a media hose) for returning a fluid (e.g. application agent (e.g. paint), air, compressed air and/or rinsing agent) from the application apparatus and/or the print head device.

The application agent is preferably a paint (e.g. water paint, solvent-based paint, base paint and/or clear paint).

However, the application agent can also comprise, e.g., a wax (e.g. preservative wax), a thickener, a sealant, an insulating material or an adhesive.

The robot hand expediently comprises a particularly fixed offset (e.g. an offset) between the first axis and the second axis, so that, e.g., the first axis and the second axis are preferably arranged fixedly offset to one another.

It is possible that the line feed-through also extends (e.g. axially) through the second joint structure. The at least one line can also preferably extend through the second joint structure.

It is possible that the first joint structure has a hollow center through which the line feed-through extends and/or the third joint structure has a hollow center through which the line feed-through extends.

The second joint structure can, e.g., also have a hollow center through which the line feed-through can advantageously extend.

The first axis and the third axis can, e.g., extend in a common plane, e.g. even if they are rotated about their axes. It is possible that the second axis crosses the common plane, preferably crosses substantially orthogonally. This can advantageously enable that, when the joint structures rotate abound their axes, the line feed-through and/or the at least one line is not kinked, but bent (and, e.g. also twisted).

It is possible that the first joint structure is an (e.g. kinematically) inlet-sided joint structure of the robot hand and/or the third joint structure is an (e.g. kinematically) outlet-sided joint structure of the robot hand.

The second joint structure can preferably be coupled (e.g. kinematically) between the first joint structure and the third joint structure.

It is possible that the first joint structure comprises a gear, preferably a strain wave gear. Alternatively or additionally, the second joint structure can comprise a gear, preferably a strain wave gear. The strain wave gear of the first joint structure and/or of the second joint structure is preferably configured as a reduction strain wave gear in order to be able to advantageously generate the required rotary moment.

A strain wave gear (e.g. also known as tension strain wave gear, sliding wedge gear or according to the English designation strain wave gear (SWG)) is a gear with, in particular, an elastic transmission element, which is advantageously characterized by an expediently high gear ratio or gear reduction and expediently high accuracy with, in particular, low weight and, in particular, small dimensions.

A gear, e.g. strain wave gear, in the context of the disclosure comprises in particular at least one of the following:
a substantially elliptical disk (e.g. wave generator). The elliptical disk can comprise, e.g., a centric hub and/or a (expediently thin and/or elliptically) deformable bearing (e.g. ball or roller bearing). The elliptical disk preferably serves as drive element of the gear; and/or
a deformable cylindrical bushing with external toothing (e.g. flex spline). The bushing serves in particular as output element of the gear; and/or
a (expediently substantially rigid) cylindrical outer ring with internal toothing (e.g. circular spline). The outer ring can preferably surround the elliptical disk and the bushing; and/or
The external toothing of the bushing preferably has at least one tooth less than the internal toothing of the outer ring.

It is possible that the first joint structure comprises a drive (e.g. motor, in particular electric motor) in order to rotate the first joint structure about the first axis. The drive of the first joint structure can be coupled, e.g. without own housing and/or without own bearing, to the first joint structure. The drive of the first joint structure can, e.g., be configured as a kit motor, which preferably comprises a rotor and a stator. In particular, the first joint structure can form a (e.g. ring-shaped) housing for its drive, wherein e.g. the housing can preferably annularly encase the drive. It is possible that the first joint structure, for cooling its drive, has, expediently externally, at least one cooling body (e.g. at least one cooling fin or cooling channel, etc.) and/or is equipped with an active cooling (e.g. for cooling by means of air, in particular compressed air, or for cooling by means of a cooling liquid).

It is possible that the second joint structure comprises a drive (e.g. motor, in particular electric motor) in order to rotate the second joint structure about the second axis. The drive of the second joint structure can be coupled, e.g. without own housing and/or without own bearing, to the second joint structure. The drive of the second joint structure can, e.g., be configured as a kit motor, which preferably comprises a rotor and a stator. In particular, the second joint structure can form a (e.g. ring-shaped) housing for its drive, wherein e.g. the housing can preferably annularly encase the drive. It is possible that the second joint structure, for cooling its drive, has, expediently externally, at least one cooling body (e.g. at least one cooling fin or cooling channel, etc.) and/or is equipped with an active cooling (e.g. for cooling by means of air, in particular compressed air, or for cooling by means of a cooling liquid).

It is possible that the third joint structure comprises a drive (e.g. motor, in particular electric motor) in order to rotate the third joint structure about the third axis. The drive of the third joint structure can be coupled, e.g. without own housing and/or without own bearing, to the third joint structure. The drive of the third joint structure can, e.g., be configured as a kit motor, which preferably comprises a rotor and a stator. In particular, the third joint structure can form a (e.g. ring-shaped) housing for its drive, wherein e.g. the housing can preferably annularly encase the drive. It is possible that the third joint structure, for cooling its drive, has, expediently externally, at least one cooling body (e.g. at least one cooling fin or cooling channel, etc.) and/or is equipped with an active cooling (e.g. for cooling by means of air, in particular compressed air, or for cooling by means of a cooling liquid).

The drive of the third joint structure can comprise e.g. a direct drive and/or e.g. be configured gearless. The direct drive can, e.g., comprise a direct motor or a torque motor. In the context of the disclosure, direct drive includes, e.g., drives in which the drive part and the working and/or output part are expediently directly connected without gear.

Highest precision without play and hysteresis loss can be realized advantageously by means of the direct drive. An in particular high-resolution measuring device that measures e.g. output-sided can be used as measuring device for rotary position measurement of the third joint structure.

It is possible that the line feed-through and preferably the at least one line extends through the drive and/or the gear of the first joint structure. Alternatively or additionally, the line feed-through and preferably the at least one line can extend through the drive of the third joint structure.

It is possible that the drive of the first joint structure comprises a motor hollow shaft and/or a gear hollow shaft, through which the line feed-through and, e.g., the at least one line extends.

It is possible that the drive of the third joint structure comprises a motor hollow shaft, through which the line feed-through and, e.g., the at least one line extends.

However, the line feed-through and, e.g., the at least one line preferably extends externally past the drive and/or the gear of the second joint structure.

In order to know the positions, in particular the rotary positions, of conventional joint structures, encoders or motor feedback systems on motor shafts are usually used in the prior art in order to be able therewith to indirectly determine the positions of the joint structures. The disadvantage here, however, is that the positions of the output determined in this way can be relatively inaccurate due to, e.g. play, wear, hysteresis, etc. in the drive train.

Measurement and/or detection, in particular directly on the joint structure, e.g. the first joint structure, the second joint structure and/or the third joint structure, and thus preferably on the output, enables an advantageously very high rotary position determination accuracy.

In order to know the positions, in particular the rotary positions, of a joint structure (e.g. the first, the second and/or the third joint structure) as precisely as possible, in the context of the disclosure (e.g. instead of encoders or motor feedback systems on motor shafts), a measuring device (e.g. optical measuring device) can be used by means of which the rotary positions of the joint structure can expediently be measured directly on the joint structure itself, so that, e.g., wear, play and/or hysteresis in the drive train of the robot hand do not lead to any or no significant deterioration in the position determination. This makes it possible, e.g., to ensure an extremely rigid drive train of the robot hand by means of post-regulation, which can, e.g., substantially only depend on the accuracy of the position determination (in particular the resolution of the measuring device) and the reaction speed and regulation quality of the overall system.

Preferably, a, in particular high-resolution, measuring device, that e.g. measures output-sided from the respective drive, can be used respectively for rotary position measurement of the first joint structure, the second joint structure and/or the third joint structure.

The robot hand can, e.g., have a (particularly optical, expediently high-resolution) measuring device for (preferably direct) rotary position measurement of the first joint structure. The measuring device can, e.g., be configured, for rotary position measurement, to detect the first joint structure expediently directly and/or to detect the first joint structure output-sided from the drive of the first joint structure, so that advantageously wear, play and/or hysteresis are not taken into account at the position determination.

It is possible that the measuring device for rotary position measurement of the first joint structure is connected to the first joint structure via a (e.g. substantially play-free and/or preloaded) coupling structure. The coupling structure can, e.g., be rotatable and/or comprise intermeshing teeth. Alternatively or additionally, the coupling structure can, e.g., be configured axis-parallel or angular and/or comprise intermeshing (e.g. conical) gear wheels. The coupling structure can, e.g., comprise a gear wheel pairing or bevel wheel stage.

It is possible that the robot hand has, e.g., an additional measuring device for (preferably drive-sided) rotary position measurement of the first joint structure. The additional measuring device can, e. g., be configured, in particular for rotary position measurement, to detect the drive of the first joint structure expediently directly. Preferably, the drive shaft (e.g. the motor and gear hollow shaft) of the drive of the first joint structure can be detected particularly directly.

The robot hand can thus comprise, e.g., an expediently output-sided measuring device and/or an expediently drive-sided measuring device for rotary position measurement of the first joint structure.

The robot hand can, e.g., have a (particularly optical, expediently high-resolution) measuring device for (preferably direct) rotary position measurement of the second joint structure. The measuring device can, e.g., be configured, for rotary position measurement, to detect the second joint structure expediently directly and/or to detect the second joint structure output-sided from the drive of the second joint structure, so that advantageously wear, play and/or hysteresis are not taken into account at the position determination.

It is possible that the robot hand has, e.g., an additional measuring device for (preferably drive-sided) rotary position measurement of the second joint structure. The additional measuring device can, e.g., be configured, in particular for rotary position measurement, to detect the drive of the second joint structure expediently directly. Preferably, the rotor or the drive shaft (e.g. the motor shaft) of the drive of the second joint structure can be detected particularly directly.

The robot hand can thus comprise, e.g., an expediently output-sided measuring device and/or an expediently drive-sided measuring device for rotary position measurement of the second joint structure.

The robot hand can, e.g., have a (particularly optical, expediently high-resolution) measuring device for (preferably direct) rotary position measurement of the third joint structure. The measuring device can, e.g., be configured, for rotary position measurement, to detect the third joint structure expediently directly and/or to detect the third joint structure output-sided from the drive of the third joint structure, so that advantageously wear, play and/or hysteresis are not taken into account at the position determination.

It is possible that the robot hand has, e.g., an additional measuring device for (preferably drive-sided) rotary position measurement of the third joint structure. The additional measuring device can, e. g., be configured, in particular for rotary position measurement, to detect the drive of the third joint structure expediently directly. Preferably, the drive shaft (e.g. the motor hollow shaft) of the drive of the third joint structure can be detected particularly directly.

The robot hand can thus comprise, e.g., an expediently output-sided measuring device and/or an expediently drive-sided measuring device for rotary position measurement of the third joint structure.

It is possible that the measuring device for rotary position measurement of the third joint structure is mounted on the second joint structure and/or is connected to the third joint structure via a (e.g. substantially play-free and/or preloaded) coupling structure. The coupling structure can, e.g., be rotatable and/or comprise intermeshing teeth. Alternatively or additionally, the coupling structure can, e.g., be configured axis-parallel or angular and/or comprise intermeshing (e.g. conical) gear wheels. The coupling structure can, e.g., comprise a gear wheel pairing or bevel wheel stage.

The measuring device of the first joint structure, the measuring device of the second joint structure and/or the measuring device of the third joint structure can, e.g., have a resolution with an error tolerance of 10 arcsec, preferably 5 arcsec, and thus in particular represent a high-resolution measuring device.

It is possible, e.g., that the additional measuring devices also have a resolution with an error tolerance of preferably 10 arcsec, in particular 5 arcsec.

The robot hand can, e.g., comprise a neutral position in which the first axis and the third axis are substantially coaxially aligned.

It is possible that, starting from the neutral position, the second joint structure has a range of rotation to one side of greater than 110°, greater than 120° or greater than 130° and, e.g., less than 150°, and/or has a range of rotation to the other side of greater than 1°, greater than 80° or greater than 90° and, e.g., less than 110°.

It is possible that the offset is between at least 10 mm and a maximum of 100 mm long, e.g. in order not to kink the at least one line at a rotation of the second joint structure about the second axis, but to enable an appropriate bending radius.

The robot hand can, e.g., comprise an application apparatus.

It is possible that the robot hand carries the application apparatus expediently directly or indirectly and/or the application apparatus is expediently directly or indirectly connected to the third joint structure.

The application apparatus preferably comprises a print head device, in particular with a plurality of nozzles for dispensing an application agent (e.g. paint), e.g. onto a motor vehicle body component (e.g. a body and/or an attachment part therefor). Alternatively, the application apparatus can also comprise another applicator, e.g. a rotary atomizer, only a single dispensing nozzle, etc.

It is possible that the at least one line comprises at least one media line for application agent supply, in particular paint supply of the application apparatus and/or the print head device. Alternatively or additionally, the at least one line can, e.g., comprise at least one media return line for returning a fluid (e.g. application agent and/or rinsing agent) from the application apparatus and/or the print head device.

Alternatively or additionally, the at least one line can comprise at least one cable for power supply of and/or for controlling the application apparatus and/or the print head device.

The robot hand can, e.g., comprise an expediently conical (advantageously repeated-accurate) socket-pin arrangement for mastering and/or calibrating the robot hand.

The disclosure also includes an application robot, preferably a painting robot, having a robot hand as disclosed herein.

The application robot is preferably a multi-axis articulated arm robot having, e.g., at least 4, at least 5 or at least 6 axes of motion.

It is possible that the third axis has a rotational speed of over 1000, 2000, 3000, 4000 or 5000°/s and/or a torsional rigidity of over 1000, 2000, 3000, 4000 or 5000 or even over 10000 Nm/arcmin.

The torsional rigidity can be achieved in particular by a post-regulation, in particular by a post-regulation of the drive of the first joint structure, the drive of the second joint structure and/or the drive of the third joint structure. For this purpose, the application robot can, e.g, comprise an electronic control device by means of which the drive of the first joint structure, the drive of the second joint structure and/or the drive of the third joint structure can be controlled and/or post-regulated.

It should be mentioned that the application apparatus, the print head device and/or the application robot is used in particular for dispensing an application agent onto a motor vehicle body component.

The application agent is preferably paint.

The line feed-through can, e.g., comprise a hose (e.g. protective and/or guide hose) or a (e.g. partially flexible) tube (e.g. protective and/or guide tube), in which the at least one line can run (advantageously protected and/or guided). The hose or the tube can advantageously form a protective cover and/or a guide structure for the at least one line.

It should also be mentioned that the line feed-through and, in particular, the at least one line can extend through a preferably substantially cylindrical joint body of the first joint structure, the second joint structure and/or the third joint structure.

It should also be mentioned that the first joint structure, the second joint structure and the third joint structure are preferably rotatable relative to one another.

The third joint structure can, e.g., be accommodated at least partially in the second joint structure.

The at least one line can expediently comprise one or more lines.

It is possible that the first joint structure can have a range of rotation about the first axis of more than +/−340°, e.g. of substantially +/−360° or of at least 360°. Alternatively or additionally, the third joint structure can have a range of rotation about the third axis of more than +/−360° or more than +/−700° or of substantially +/−720°.

In the context of the disclosure, the drive trains are preferably configured to be as direct as possible and are preferably not coupled to one another. They use in the toothing preferably play-free strain wave gears for the first joint structure and/or the second joint structure in order to expediently generate the output torques required here. Due to its often lower load, the third joint structure can, e. g., completely dispense with a gear. Here, a direct drive and/or torque drive can therefore be realized, which advantageously has maximum rigidity without mechanical play.

The preferred embodiments and features of the disclosure described above can be combined with one another.

The preferred embodiments of the disclosure described with reference to the figures correspond in part, wherein similar or identical parts are provided with the same reference signs and reference can also be made to the description of the other embodiments in order to avoid repetitions.

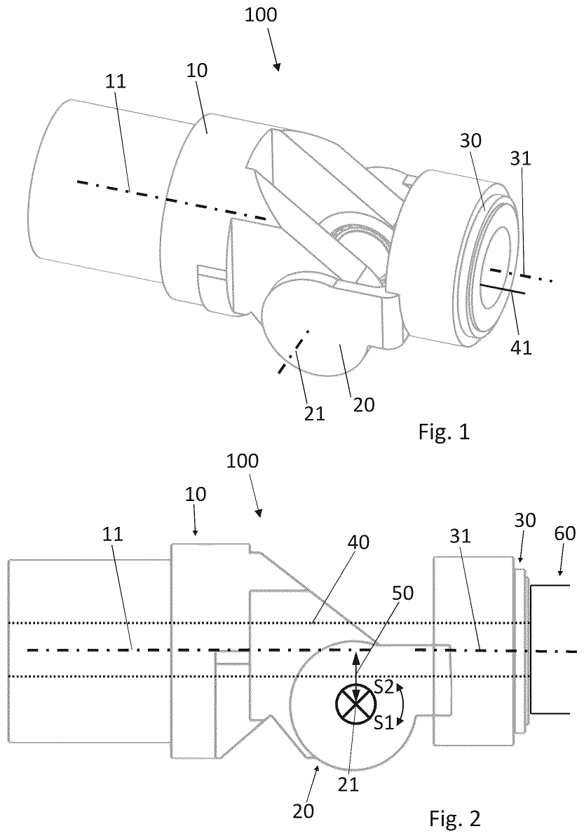

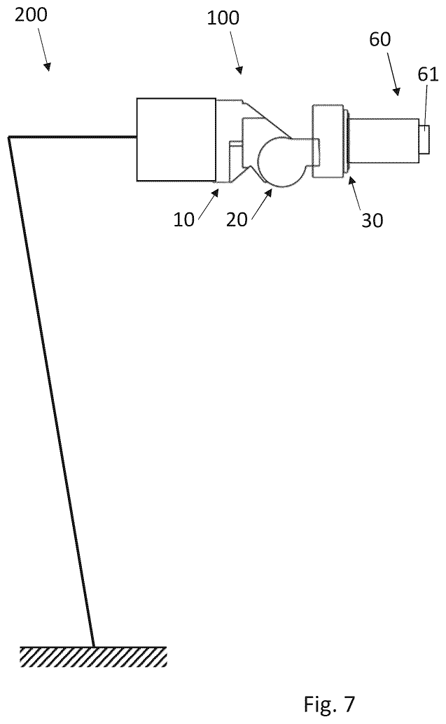

FIGS. 1 to 3 show different views of a robot hand 100 according to an embodiment of the disclosure. The robot hand 100 is used in particular for carrying an application apparatus 60 and for mounting to an application robot 200 (FIG. 7).

The robot hand 100 comprises a first joint structure 10 which is rotatable about a first axis 11, a second joint structure 20 which is rotatable about a second axis 21, and a third joint structure 30 which is rotatable about a third axis 31. Thus, the first joint structure 10, the second joint structure 20 and the third joint structure 30 are rotatable relative to each other.

The first joint structure 10 can preferably be a kinematically inlet-sided joint structure of the robot hand 100, wherein the third joint structure 30 can in particular be a kinematically outlet-sided joint structure of the robot hand 100.

The second joint structure 20 can preferably be coupled kinematically between the first joint structure 10 and the third joint structure 30 and, e.g., form a connecting structure of the first joint structure 10 with the third joint structure 30.

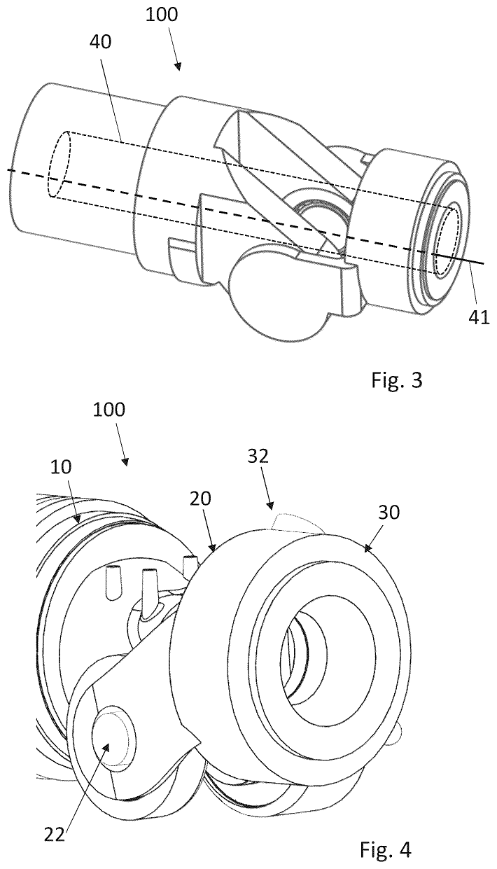

The robot hand 100 can comprise an application apparatus 60, which can only be partially seen in FIG. 2 and which can be carried expediently directly or indirectly by means of the robot hand 100, in particular by means of the third joint structure 30. The application apparatus 60 can in particular comprise a print head device 61 (FIG. 7), wherein the print head device 61 can have a plurality of nozzles for dispensing an application agent (e.g. paint) onto a motor vehicle body component (e.g. a body and/or an attachment part therefor). The application agent can, e.g., be dispensed from the nozzles in the form of contiguous application agent jets and/or, e.g., in the form of application agent droplets, etc. The print head device 61 is used in particular for substantially overspray-free coating, in particular painting.

The robot hand 100 comprises a line feed-through 40 which extends through the first joint structure 10 and through the third joint structure 30 and in which preferably at least one line 41 for the application apparatus 60 and/or for the print head device 61 runs.

The line feed-through 40 can, e.g., comprise a hose or a (e.g. partially flexible) tube, in which the at least one line 41 can run preferably in a protected and guided manner. The hose or the tube can thus form a protective cover and/or a guiding structure for the at least one line 41.

The robot hand 100 also comprises a fixed offset 50 between the first axis 11 and the second axis 21. The offset 50 can, e.g., be between at least 10 mm and a maximum of 100 mm long.

The at least one line 41, which runs in the line feed-through 40, preferably serves for application agent supply and thus in particular for paint supply of the application apparatus 60 and/or the print head device 61. However, the at least one line 41 can also serve, e.g., for electrical power supply, for control and/or for fluid supply (e.g. air, compressed air and/or rinsing/cleaning agent) of the application apparatus 60 and/or the print head device 61. The at least one line 41 can also comprise, e.g., a data cable by means of which data can be transmitted from and/or to the print head device 61 and/or the application apparatus 60.

The line feed-through 40 can preferably also extend through the second joint structure 20.

The first axis 21 and the third axis 31 can extend in a common plane.

The second axis 21 crosses the common plane, preferably substantially orthogonally.

FIG. 2 shows the robot hand 100 in a neutral position, in which the first axis 11 and the third axis 31 are substantially coaxially aligned. Starting from the neutral position, the second joint structure 20 can have a range of rotation to one side S1 of, e.g., greater than 120° or greater than 130° and of, e. g., less than 150° and/or can have a range of rotation to the other side S2 of, e.g., greater than 1°, greater than 80° or greater than 90° and of, e.g., less than 110°.

In order to rotate the first joint structure 10 about the first axis 11, the first joint structure 10 comprises a drive. The drive comprises in particular a drive motor (e.g. electric motor) and is coupled, preferably without own housing and/or without own bearing, to the first joint structure 10. The drive of the first joint structure 10 can thus be configured as, e.g., a kit motor. The drive of the first joint structure 10 can comprise a motor hollow shaft and, e.g., a gear hollow shaft, through which the line feed-through 40 and the at least one line 41 can extend.

In order to rotate the second joint structure 20 about the second axis 21, the second joint structure 20 comprises a drive. In The drive comprises in particular a drive motor (e.g. electric motor) and is coupled, preferably without own housing and/or without own bearing, to the second joint structure 20. The drive of the second joint structure 20 can thus be configured as, e.g., a kit motor. The line feed-through 40 and the at least one line 41 extend laterally externally past the drive and/or the gear of the second joint structure 20.

In order to rotate the third joint structure 30 about the third axis 31, the third joint structure 30 comprises a drive. The drive comprises in particular a drive motor (e.g. electric motor) and is coupled, preferably without own housing and/or without own bearing, to the third joint structure 30. The drive of the third joint structure 30 can thus be configured as, e.g., a kit motor. The drive of the third joint structure 30 can comprise a motor hollow shaft and, e.g., a gear hollow shaft, through which the line feed-through 40 and the at least one line 41 can extend.

It is therefore particularly preferred that preferably all three joint structures 10, 20 and 30 can be driven via motors which can be integrated without own housings directly into the respective joint structure 10, 20 and 30. Thereby, the joint structures 10, 20 and 30 can respectively form an expediently ring-shaped housing for their drive.

The drive of the third joint structure 30 can, e.g., comprise a direct motor, in particular a torque motor, and/or be configured e.g. gearless. Direct motor, torque motor and/or gearless drive includes in particular drives in which the drive part and the working and/or output part are connected without gear expediently directly to each other.

The first joint structure 10 can comprise a gear, preferably a substantially play-free strain wave gear. The second joint structure 20 can also comprise a gear, preferably a substantially play-free strain wave gear.

A strain wave gear (e.g. also known as tension strain wave gear, sliding wedge gear or according to the English designation strain wave gear (SWG)) is a gear with, in particular, an elastic transmission element, which is advantageously characterized by an expediently high gear ratio and expediently high rigidity.

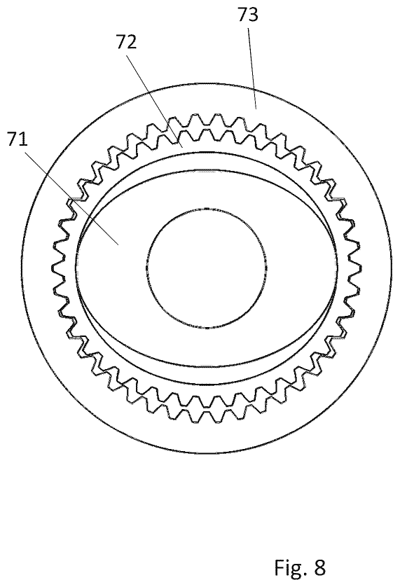

A strain wave gear, as can preferably be used for the first joint structure 10 and/or the second joint structure 20, is described below with reference to FIG. 8.

The strain wave gear comprises in particular an elliptical disk 71, a deformable substantially cylindrical bushing 72 with external toothing and a substantially cylindrical outer ring 73 with internal toothing.

The elliptical disk 71 (e.g. wave generator) can, e.g., include a centric hub and a (expediently thin and/or elliptically) deformable bearing (e.g. ball or roller bearing). The elliptical disk 71 preferably serves as drive element of the gear. The cylindrical bushing 72 (e.g. flexspline) serves in particular as output element of the gear. The outer ring 73 (e.g. circular spline) can preferably surround the elliptical disk 71 and the bushing 72 and/or form a housing for the elliptical disk 71 and the bushing 72.

FIG. 4 shows a perspective view of the robot hand 100, wherein in particular a measuring device 22 can be seen in FIG. 4.

The measuring device 22 is used for (preferably direct) rotary position measurement of the second joint structure 20, wherein the measuring device 22 can, e.g., be configured, for rotary position measurement, to detect the second joint structure 20 directly and/or to detect (e.g. optically, with spatial spacing, with physical engagement, contacting or contactless, etc.) it output-sided from the drive of the second joint structure 20. This makes it advantageously possible that wear, play and/or hysteresis in the drive train of the robot hand 100 do not lead to any or no significant deterioration in the accuracy of the position determination.

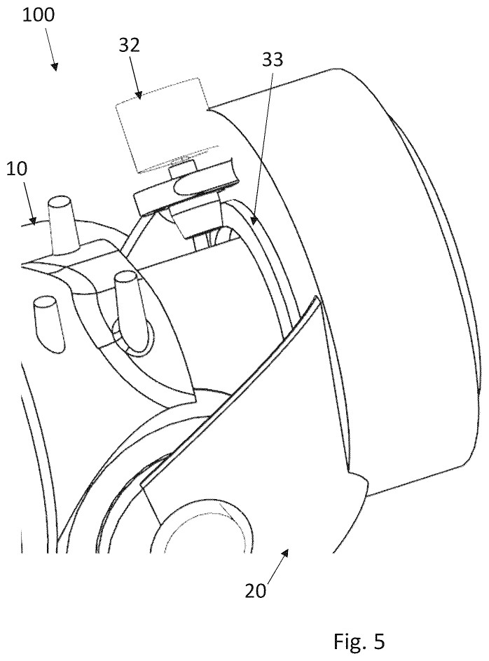

FIG. 5 shows a perspective view of the robot hand 100, wherein in particular a measuring device 32 can be seen in FIG. 5.

The measuring device 32 is used for (preferably direct) rotary position measurement of the third joint structure 30, wherein the measuring device 32 can, e.g., be configured, for rotary position measurement, to detect the third joint structure 30 directly and/or to detect (e.g. optically, with spatial spacing, with physical engagement, contacting or contactless, etc.) it output-sided from the drive of the third joint structure 30. This makes it advantageously possible that wear, play and/or hysteresis in the drive train of the robot hand 100 do not lead to any or no significant deterioration in the accuracy of the position determination.

It is possible, e.g., as can be seen in FIG. 5, that the measuring device 32 for rotary position measurement of the third joint structure 30 is mounted, e.g., on the second joint structure 20 and, in particular, is connected to the third joint structure 30 via a preferably substantially play-free, preloaded coupling structure 33, preferably a gear wheel pairing and/or a bevel wheel stage, in order to thus enable a direct and/or output-sided rotary position measurement. The coupling structure 33 is preferably configured angularly, e.g. as a bevel wheel stage, wherein axis-parallel coupling structures 33 are also possible. In particular, the coupling structure 33 can comprise intermeshing (e.g. conical) gear wheels.

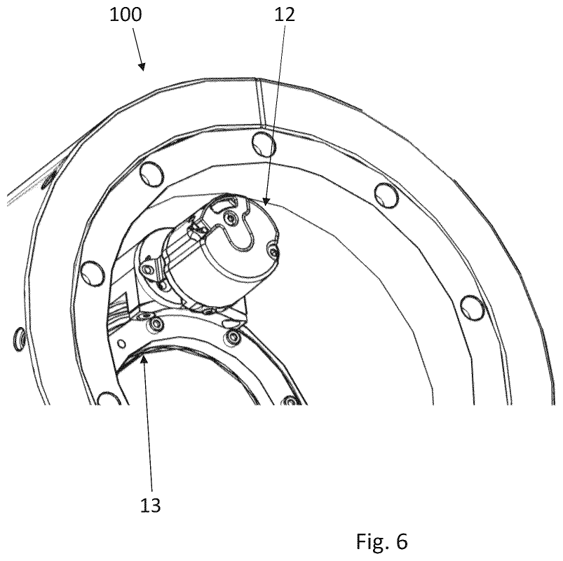

FIG. 6 shows a perspective view of the robot hand 100, wherein in particular a measuring device 12 can be seen in FIG. 6.

The measuring device 12 is used for (preferably direct) rotary position measurement of the first joint structure 10, wherein the measuring device 12 can, e.g., be configured, for rotary position measurement, to detect the first joint structure 10 directly and/or to detect (e.g. optically, with spatial spacing, with physical engagement, contacting or contactless, etc.) it output-sided from the drive of the first joint structure 10. This makes it advantageously possible that wear, play and/or hysteresis in the drive train of the robot hand 100 do not lead to any or no significant deterioration in the accuracy of the position determination.

It is possible, e.g., as can be seen in FIG. 6, that the measuring device 12 for rotary position measurement of the first joint structure 10 is connected to the first joint structure 10 via a preferably substantially play-free, preloaded coupling structure 13, preferably a gear wheel pairing and/or a bevel wheel stage, in order to thus enable a direct and/or output-sided rotary position measurement. The coupling structure 13 is preferably configured axis-parallel, e.g. by means of intermeshing conical gear wheels, wherein angular coupling structures 13 are also possible.

The measuring devices 12, 22 and 32 can, e.g., be optical, expediently high-resolution measuring devices, in particular with a resolution with an error tolerance of 10 or 5 arcsec (arcsec=angular seconds). However, the measuring devices 11, 22 and 32 are not limited to optical measuring devices, but can include any other suitable measuring technology.

It is possible that the robot hand 100 comprises an additional measuring device, not shown in the figures, for in particular drive-sided rotary position measurement of the first joint structure 10. This additional measuring device can, e.g., be configured, in particular for rotary position measurement, to (expediently directly) detect the drive (e.g. its drive shaft, in particular the motor and gear hollow shaft) of the first joint structure 10. This additional measuring device can, e.g., be connected directly to the drive shaft.

The robot hand 100 can, e.g., comprise an additional measuring device, not shown in the figures, for in particular drive-sided rotary position measurement of the second joint structure 20. This additional measuring device can, e.g., be configured to (expediently directly) detect the drive (e.g. its rotor or drive shaft) of the second joint structure 20. Alternatively or additionally, the robot hand 100 can, e.g., comprise an additional measuring device, not shown in the figures, for in particular drive-sided rotary position measurement of the third joint structure 30. This additional measuring device can, e.g., be configured, in particular for rotary position measurement, to (expediently directly) detect the drive (e.g. its drive shaft, in particular the motor hollow shaft) of the third joint structure 30.

Consequently, the robot hand 100 can comprise, e.g., an in particular output-sided measuring device 12, 22, 32 and/or an in particular drive-sided measuring device for rotary position measurement of the first joint structure 10, the second joint structure 20 and/or the third joint structure 30.

FIG. 7 shows a schematic view of an application robot 200 with robot hand 100.

The application robot 200 is preferably a painting robot and carries an application apparatus 60 by means of the robot hand 100. The application apparatus 60 preferably comprises a print head device 61 with a plurality of nozzles for dispensing the application agent (e.g. paint). However, the application apparatus 60 can also comprise an applicator other than a print head, e.g. an atomizer or only one nozzle, etc.

The at least one line 41, which extends through the line feed-through 40, preferably comprises a media line for application agent supply and/or for fluid supply (e.g. air, rinsing/cleaning agent, compressed air, etc.) of the application apparatus 60 and/or the print head device 61. However, the at least one line 41 can alternatively or additionally comprise, e.g., a cable for control of and/or for preferably electrical power supply to the application apparatus 60 and/or print head device 61.

Benefits of the disclosure are, e.g.:
significant increase in the mechanical accuracy of the robot hand 100, e.g. by play-free gears on the joint structures 10 and 20 and e.g. direct drive of the joint structure 30,
direct measuring system on the robot hand 100, in particular on the joint structures 10, 20 and 30,
media guidance (e.g. fluid guidance, in particular paint, air, compressed air and/or cleaning/rinsing agent) and/or cable guidance through the robot hand 100,
large range of movement, in particular of the joint structure 20, e.g. from approximately 100° to approximately 140°,
high rigidity of the robot hand 100, and/or
good dynamics of the robot hand 100 due to small masses to be accelerated.

The disclosure is not limited to the preferred embodiments described above. Rather, a large number of variants and modifications are possible which also make use of the concept of the disclosure and therefore fall within the scope of protection. Furthermore, the disclosure also claims protection for the subject-matter and the features of the subclaims independently of the features and claims referred to.

1.-37. (canceled)

38. A robot hand that carries an application apparatus having a print head device, comprising:
a first joint structure rotatable about a first axis
a second joint structure rotatable about a second axis, and
a third joint structure rotatable about a third axis, wherein a line feed-through extends through the first joint structure and through the third joint structure and
an offset between the first axis and the second axis.

39. The robot hand according to claim 38, wherein the line feed-through extends through the second joint structure.

40. The robot hand according to claim 38 wherein at least one of the first or third joint structures have a hollow center through which the line feed-through extends.

41. The robot hand according to claim 38 wherein the first axis and the third axis extend in a common plane.

42. The robot hand according to claim 41 wherein the second axis crosses the common plane, preferably crosses it substantially orthogonally.

43. The robot hand according to claim 38 wherein the first joint structure is a kinematically inlet-sided joint structure and the third joint structure is a kinematically outlet-sided joint structure.

44. The robot hand according to claim 38 wherein the second joint structure is coupled kinematically between the first joint structure and the third joint structure.

45. The robot hand according to claim 38 wherein the first joint structure comprises a gear, and the second joint structure comprises a gear.

46. The robot hand according to claim 45 wherein the gear of the first joint structure is a strain wave gear, and the gear of the second joint structure is a strain wave gear.

47. The robot hand according to claim 38 wherein at least one of the first, second or third joint structures comprise a drive to rotate the joint structure about its axis.

48. The robot hand according to claim 47 wherein at least one of the drive of the first, second or third joint structures are coupled, without its own housing and without its own bearing, to the first joint structure.

49. The robot hand according to claim 47 wherein at least one of the first, second or third joint structures forms a ring-shaped housing for its drive.

50. The robot hand according to claim 47 wherein at least one of the first, second or third joint structures has externally at least one cooling body.

51. The robot hand according to claim 38 wherein the drive of the third joint structure comprises a direct drive.

52. The robot hand according to claim 45 wherein the line feed-through extends through at least one of the drive of the first or third joint structure.

53. The robot hand according to claim 47 wherein the drive of one of the first or third joint structures comprise a motor and gear hollow shaft through which the line feed-through extends.

54. The robot hand according to claim 45 wherein the line feed-through extends externally past at least one of the drive or the gear of the second joint structure.

55. The robot hand according to claim 38 wherein the robot hand has a measuring device which measured a rotary position measurement of the first joint structure.

56. The robot hand according to claim 55, wherein the measuring device is configured to detect the first joint structure either directly or from an output-side of the first joint structure.

57. The robot hand according to claim 55 wherein the measuring device is connected to the first joint structure with a play-free and/or preloaded, coupling structure.

58. The robot hand according to claim 55 wherein the robot hand has an additional measuring device for drive-sided rotary position measurement of the first joint structure.

59. The robot hand according to claim 38 wherein the robot hand has a measuring device for rotary position measurement of the second joint structure.

60. The robot hand according to claim 59 wherein the measuring device detects one of the second joint structure directly or at an output-sided from the drive of the second joint structure.

61. The robot hand according to claim 38 wherein the robot hand has a measuring device for rotary position measurement of the third joint structure.

62. The robot hand according to claim 61 wherein the measuring device is configured, for rotary position measurement to detect either the third joint structure directly or to detect the third joint structure output-sided from the drive of the third joint structure.

63. The robot hand according to claim 61 wherein the measuring device for rotary position measurement of the third joint structure is either mounted on the second joint structure or is connected to the third joint structure via a, preferably play-free and/or preloaded, coupling structure.

64. The robot hand according to claim 58 wherein the coupling structure of one of the first joint structure or the coupling structure of the third joint structure:
is rotatable, and/or
has intermeshing teeth, and/or
is configured axis-parallel or angular, and/or
has intermeshing conical gear wheels.

65. The robot hand according to claim 55 wherein the measuring device of at least one of the first, second or third joint structures has a resolution with an error tolerance of 10 arc/sec, preferably 5 arc/sec.

66. The robot hand according to claim 38 wherein the robot hand has a neutral position in which the first axis and the third axis are substantially coaxially aligned.

67. The robot hand according to claim 66 wherein the second joint structure, starting from the neutral position:
has a range of rotation of greater than 120° or greater than 130° to one side (S1), and/or
has a range of rotation of greater than 1°, greater than 80° or greater than 90° to the other side.

68. The robot hand according to claim 38 wherein:
the first joint structure has a range of rotation about the first axis of more than +/−340° or of at least+/−360°, and/or
the third joint structure has a range of rotation about the third axis of more than +/−340° or at least+/−360° or at least+/−700°.

69. The robot hand according to claim 38 wherein the offset is between 10 mm and 100 mm.

70. The robot hand according to claim 38 further comprising at least one line and wherein the at least one line
comprises at least one media line for application agent supply and/or for fluid supply of the application apparatus and/or the print head device, and/or
comprises at least one media return line for returning a fluid from the application apparatus and/or the print head device.

71. The robot hand according to claim 70 wherein the at least one line comprises at least one cable for power supply.

72. The robot hand according to claim 38 wherein the line feed-through, preferably in the first joint structure and/or in the third joint structure, has a passage cross-section of at least 40 mm to maximal 90 mm, preferably of 70 mm+/−5 mm.
